(19) United States
(12) Patent Application Publication
(10) Pub. No.: US 2012/0116856 A1
(43) Pub. Date: May 10, 2012

(54) COMPUTERIZED SYSTEM AND METHODOLOGY FOR SALE OF PRODUCTS BY DRAW

(75) Inventors: Oren Eldad, Tel Aviv (IL); Patrick Reich, Berlin (DE)

(73) Assignee: RPR HOLDING GMBH, Berlin (DE)

(21) Appl. No.: 12/941,729

(22) Filed: Nov. 8, 2010

(51) Int. Cl. G06Q 30/00

(52) U.S. Cl. 705/14.14

(57) ABSTRACT

A system for selling products on-line including a seller module providing functionality for offering a product, establishing a minimum price for the product, and establishing at least one of a target price higher than the minimum price, and an offer expiration date; a transaction engine publishing the offering of the product; and a buyer module, providing functionality for purchasing, by potential acquirers of the product, rights to participate in a draw for the product; and wherein the transaction engine is operative to automatically conduct the draw in accordance with criteria which include purchase by potential acquirers of rights for a total amount not less than the minimum price, and arrival of offer expiration date or purchase by potential acquirers of the product of rights for a total amount which is not less than target price, and wherein transaction engine is also operative to award the product to winner of draw.

### FIELD OF THE INVENTION

The present invention relates to systems and methods for selling products on-line.

### BACKGROUND OF THE INVENTION

The following publications are believed to represent the current state of the art and are hereby incorporated by reference:

U.S. Pat. Nos.: 4,799,156; 5,774,873; 5,794,207; 5,794,219; 5,890,138; 5,924,082; 6,085,169; 6,101,484; 6,108,639; 6,119,100; 6,131,087; 6,134,534; 6,167,386; 6,199,050; 6,240,396; 6,260,024; 6,266,651; 6,285,989; 6,356,878; 6,415,270; 6,535,880; 6,598,026; 6,847,939; 6,873,968 and 7,617,128;

U.S. Published Patent Application Nos.: 2002/0077927 and 2007/0250397; and

RaffleMine online raffle at http://www.rafflemine.com.

### SUMMARY OF THE INVENTION

The present invention seeks to provide systems and methods for selling products on-line.

There is thus provided in accordance with a preferred embodiment of the present invention a system for selling products on-line including a seller module providing the following functionality: offering of a product, by a seller, by interaction with a web site, establishing a minimum price for the product, by the seller, by interaction with the web site, and establishing at least one of a target price, which is higher than the minimum price, and an offer expiration date, by the seller, by interaction with the web site; a transaction engine publishing the offering of the product on the web site; and a buyer module, providing the following functionality: purchasing, by potential acquirers of the product, rights to participate in a draw for the product by interaction with the web site, and wherein the transaction engine is operative to automatically conduct the draw in accordance with predetermined criteria which include both purchase by potential acquirers of the product of rights for a total amount which is not less than the minimum price, and either arrival of the offer expiration date or purchase by potential acquirers of the product of rights for a total amount which is not less than the target price, and wherein the transaction engine is also operative to award the product to the winner of the draw.

Alternatively, the predetermined criteria include both purchase by potential acquirers of the product of rights for a total amount which is not less than the minimum price and arrival of the offer expiration date. Alternatively, the predetermined criteria include purchase by potential acquirers of the product of rights for a total amount which is not less than the target price.

Preferably, the offering of a product includes providing descriptive details of the product. Additionally or alternatively, the rights to participate in a draw include multiple rights to participate in the draw. Preferably, the price of the rights to participate in a draw is independent of the actual value of the product.

Additionally, the transaction engine is also operative to notify the seller of the winner of the draw. Preferably, upon receiving confirmation of delivery of the product to the winner of the draw, the transaction engine is also operative to award the seller of the product the value of the total amount of rights purchased to participate in the draw. Alternatively, the transaction engine is also operative to award the seller of the product part of the value of the total amount of rights purchased to participate in the draw and to transfer to an owner or an operator of the system a remaining part of the value of the total amount of rights purchased to participate in the draw for the product.

Preferably, when the predetermined criteria are not fulfilled and the transaction engine does not automatically conduct the draw, the transaction engine is operative to refunds the total amount of rights purchased to participate in the draw for the product.

There is also provided in accordance with another preferred embodiment of the present invention a method of selling products on-line including offering of a product, by a seller, by interaction with a web site, establishing a minimum price for the product, by the seller, by interaction with the web site, establishing at least one of a target price, which is higher than the minimum price, and an offer expiration date, by the seller, by interaction with the web site, publishing the offering of the product on the web site, purchasing, by potential acquirers of the product, rights to participate in a draw for the product by interaction with the web site, automatically conducting the draw in accordance with predetermined criteria which include both purchase by potential acquirers of the product of rights for a total amount which is not less than the minimum price, and either arrival of the offer expiration date or purchase by potential acquirers of the product of rights for a total amount which is not less than the target price, and awarding the product to the winner of the draw.

Alternatively, the predetermined criteria include both purchase by potential acquirers of the product of rights for a total amount which is not less than the minimum price and arrival of the offer expiration date. Alternatively, the predetermined criteria include purchase by potential acquirers of the product of rights for a total amount which is not less than the target price.

Preferably, the offering of a product includes providing descriptive details of the product. Additionally or alternatively, the rights to participate in a draw include multiple rights to participate in the draw. Preferably, the price of the rights to participate in a draw is independent of the actual value of the product.

Additionally, the transaction engine is also operative to notify the seller of the winner of the draw. Preferably, upon receiving confirmation of delivery of the product to the winner of the draw, the transaction engine is also operative to award the seller of the product the value of the total amount of rights purchased to participate in the draw. Alternatively, the transaction engine is also operative to award the seller of the product part of the value of the total amount of rights purchased to participate in the draw and to transfer to an owner or an operator of the web site a remaining part of the value of the total amount of rights purchased to participate in the draw for the product.

Preferably, when the predetermined criteria are not fulfilled and the transaction engine does not automatically conduct the draw, the transaction engine is operative to refund the total amount of rights purchased to participate in the draw for the product.

### BRIEF DESCRIPTION OF THE DRAWINGS

The present invention will be more fully understood and appreciated from the following detailed description, taken in conjunction with the drawings in which:

FIGS. 1A, 1B, 1C, 1D & 1E are simplified pictorial illustrations of the operation of a system for selling products on-line, constructed and operative in accordance with a preferred embodiment of the present invention;

FIG. 2 is a simplified block diagram illustration of a preferred embodiment of the system of FIGS. 1A-1E; and

FIG. 3 is a simplified flow chart illustrating operation of the system of FIGS. 1A-2 in accordance with a preferred embodiment of the present invention.

### DETAILED DESCRIPTION OF PREFERRED EMBODIMENT

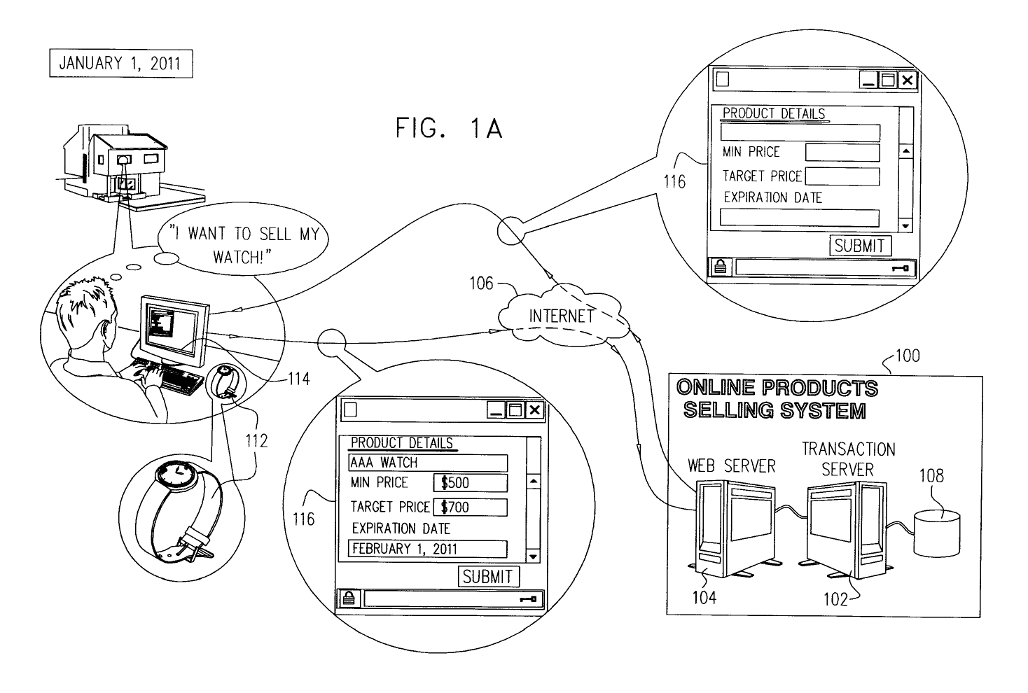

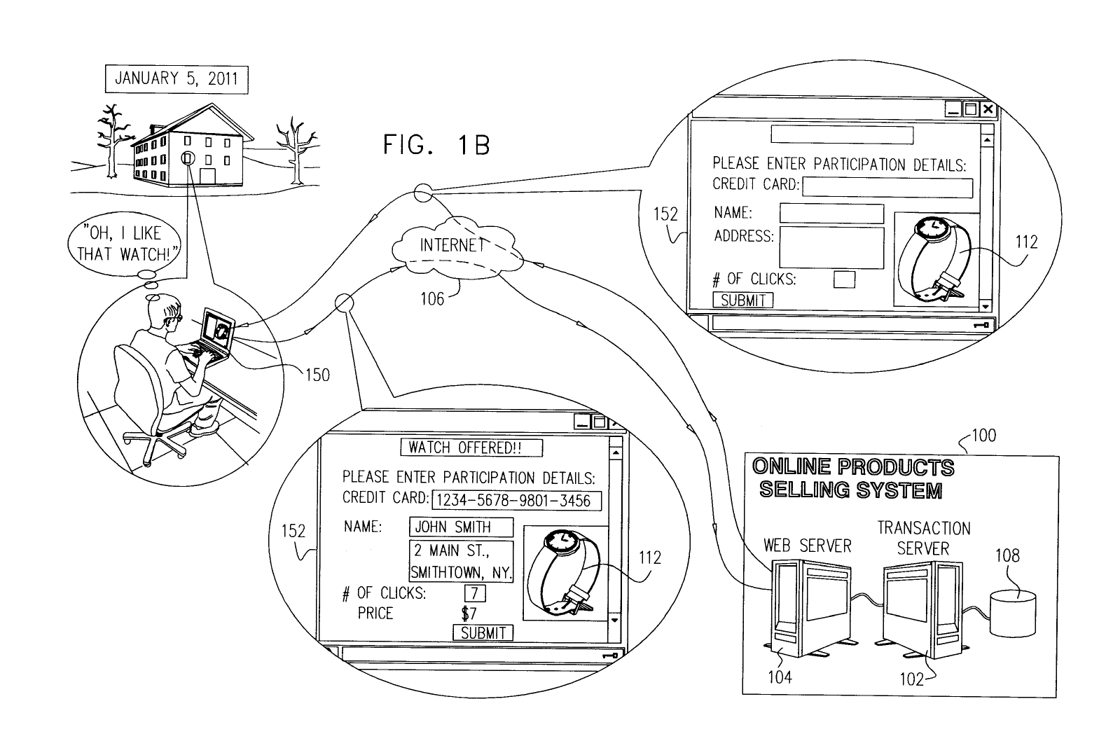

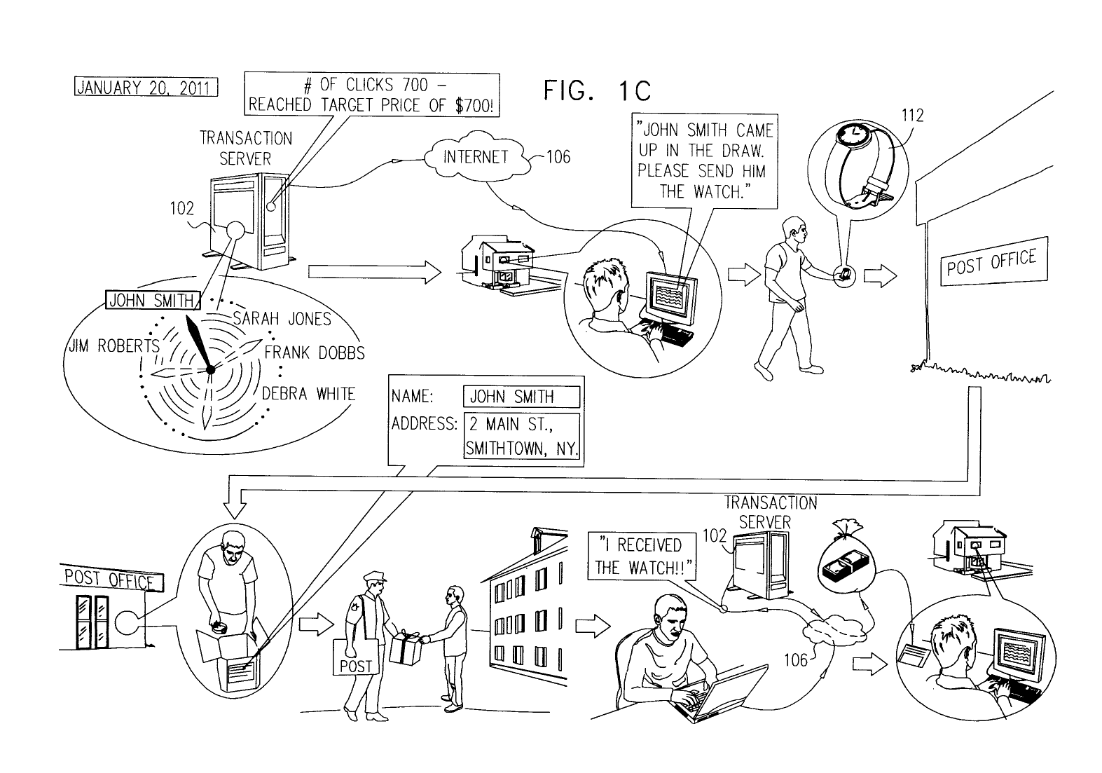

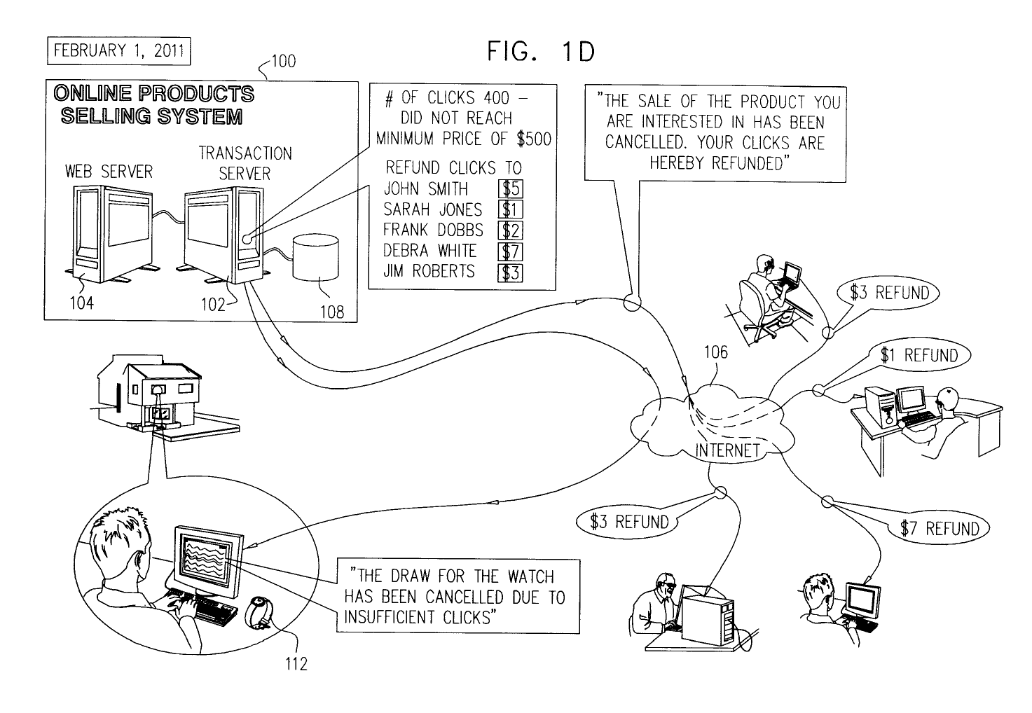

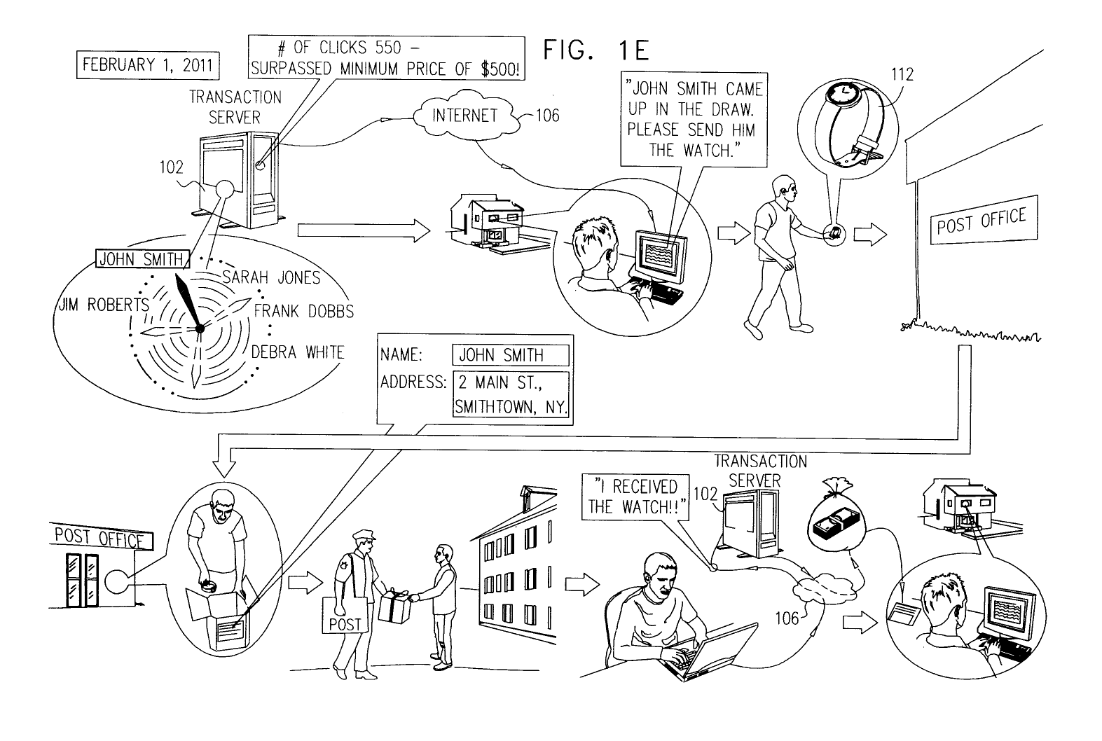

Reference is now made to FIGS. 1A, 1B, 1C, 1D & 1E, which are simplified pictorial illustrations of the operation of a system for selling products on-line, constructed and operative in accordance with a preferred embodiment of the present invention. The system of FIGS. 1A-1E includes a seller module, which provides functionality for offering of a product, by a seller, by interaction with a web site operated by the web server, establishing a minimum price for the product, by the seller, by interaction with the web site, and establishing at least one of a target price, which is higher than the minimum price, and an offer expiration date, by the seller, by interaction with the web site.

The system of FIGS. 1A-1E also includes a transaction engine which publishes the offering of the product on the web site, and a buyer module which provides functionality for purchasing, by potential acquirers of the product, rights to participate in a draw for the product by interaction with the web site. The transaction engine is operative to automatically conduct the draw in accordance with predetermined criteria which include both purchase, by potential acquirers of the product, of rights for a total amount which is not less than the minimum price, and either arrival of the offer expiration date or purchase by potential acquirers of the product of rights for a total amount which is not less than the target price. The transaction engine is also operative to award the product to the winner of the draw.

As seen in FIG. 1A, the system for selling products on-line 100 preferably includes a transaction server 102 and a web server 104 which is connected to the internet 106. Transaction server 102 and web server 104 are preferably interconnected via a computer network. Alternatively, transaction server 102 and web server 104 may reside on a single computer. System 100 also preferably includes a database 108.

As shown in FIG. 1A, on Jan. 1, 2011, a seller decides to utilize the system for selling products on-line 100 to offer a wristwatch 112 for sale on-line. Using a web browser 114, the seller accesses web server 104 via the internet 106 and enters the details of an online offering of wristwatch 112 into a form that is preferably included in a web page 116 which is downloaded from web server 104. The details include a description of wristwatch 112, a minimum price of $500 for wristwatch 112, a target price for wristwatch 112, for example $700, which is higher than the minimum price, and a future offer expiration date of Feb. 1, 2011. The seller submits the details of the online offering of wristwatch 112, preferably by clicking on a “submit” button on the form included in web page 116, which causes web browser 114 to transmit the details in the form included in web page 116 to web server 104 via the internet 106. Web server 104 preferably transmits the details to transaction server 102 which then stores the details in database 108.

Turning now to FIG. 1B, on Jan. 5, 2011, a potential acquirer of wristwatch 112 uses a browser 150 to access web server 104 via the internet 106 and to download a web page 152 which advertises wristwatch 112 offered for sale by the seller of FIG. 1A. As seen in FIG. 1B, web page 152 includes a form for entering personal details of a potential acquirer purchasing rights to participate in a draw for wristwatch 112. The personal details preferably include a name and address, details of a credit\debit card or of any other personal payment system, and the number of “clicks” the user would like to purchase.

For the purposes of this application, a “click” is a unit of participation in a draw for a particular product offered for sale by a seller using system 100. A single “click” grants the potential acquirer of the particular product a single chance of winning the draw for the particular product and being awarded the product. Each additional click purchased by the potential acquirer grants the potential acquirer an additional chance of winning the draw. The price of a single click, for example $1, is preferably predetermined by the system, and may be independent of the actual value of the product.

Upon completing the form displayed in web page 152, the potential acquirer submits the form, preferably by clicking on a “submit” button which causes web browser 150 to transmit the details in the form included in web page 152 to web server 104 via the internet 106. Web server 104 preferably transmits the details to transaction server 102 which then stores the details in database 108. Transaction server 102 preferably charges the potential acquirer for the clicks purchased.

It is a particular feature of the present invention that transaction server 102 continuously monitors database 108 and compares the total value of clicks purchased for each product to the target price of the product as set by the seller of the product. Turning now to FIG. 1C, it is seen that on Jan. 20, 2011, the number of purchased clicks to participate in the draw for wristwatch 112 has reached 700, which at a value of $1 per click is equivalent to the target price of $700 set by the seller of wristwatch 112. Transaction server 102 then immediately conducts the draw for wristwatch 112, and one of the potential acquirers of wristwatch 112, such as John Smith, wins the draw. Transaction server 102 sends a notification via the internet to the seller of wristwatch 112, notifying the seller that John Smith is entitled to the wristwatch 112, and requesting that the seller send the wristwatch 112 to John Smith. Alternatively, the seller may be notified via other means, such as by telephone or mail.

As seen in FIG. 1C, upon receiving the notification from transaction server 102, the seller proceeds to deliver the wristwatch 112 to John Smith, preferably via mail or courier, Upon receiving confirmation that the wristwatch 112 has been delivered, the seller is credited by the system 100 with a sum which may be equal to or less than the total value of purchased clicks to participate in the draw. The difference between the sum credited to the seller and the total value of purchased clicks to participate in the draw may be transferred to the owner or operator of system 100.

Alternatively, as seen in FIG. 1D, on the expiration date of Feb. 1, 2011, which expiration date was set by the seller of FIG. 1A, the total value of purchased clicks to participate in the draw for wristwatch 112 did not reach the minimum price set by the seller of wristwatch 112. The transaction server 102 therefore cancels the sale of wristwatch 112 and refunds the value of clicks purchased by all potential acquirers of wristwatch 112. Additionally, the seller is notified that the draw has been cancelled due to insufficient purchase of participating clicks.

Alternatively, as seen in FIG. 1E, on the expiration date of Feb. 1, 2011, which expiration date was set by the seller, the total value of clicks purchased to participate in the draw for wristwatch 112 surpassed the minimum price of $500 set by the seller of wristwatch 112, but was still less than the target price of $700. Transaction server 102 then immediately conducts the draw for wristwatch 112, and one of the potential acquirers of wristwatch 112, such as John Smith, wins the draw. Transaction server 102 sends a notification via the internet to the seller of wristwatch 112, notifying the seller that John Smith is entitled to the wristwatch 112, and requesting that the seller send the wristwatch 112 to John Smith. Alternatively, the seller may be notified via other means, such as by telephone or mail.

As seen in FIG. 1E, upon receiving the notification from transaction server 102, the seller proceeds to deliver the wristwatch 112 to John Smith, preferably via mail or courier, Upon receiving confirmation that the wristwatch 112 has been delivered, the seller is credited by the system 100 with a sum which may be equal to or less than the total value of purchased clicks to participate in the draw. The difference between the sum credited to the seller and the total value of purchased clicks to participate in the draw may be transferred to the owner or operator of system 100.

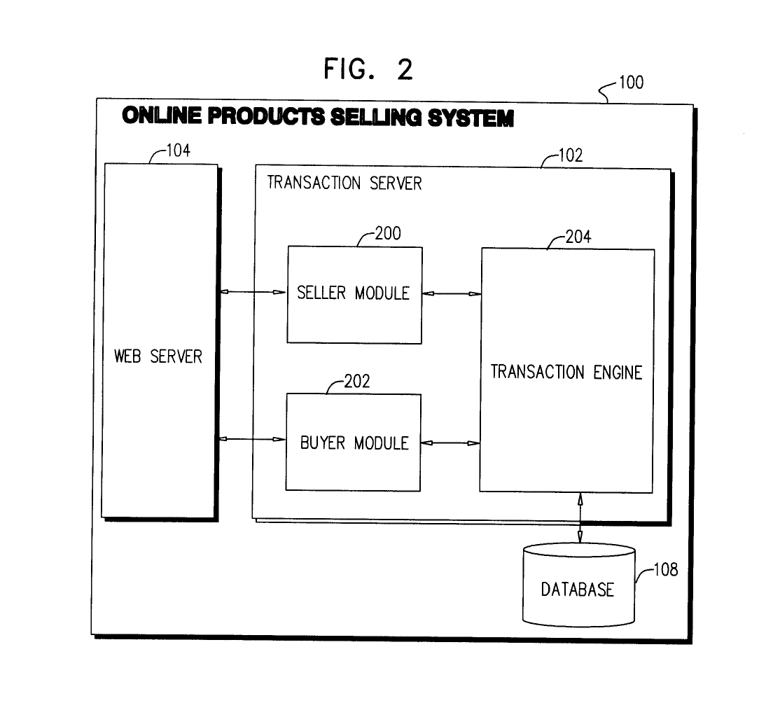

Reference is now made to FIG. 2 which is a simplified block diagram illustration of a preferred embodiment of the system of FIGS. 1A-1E. As seen in FIG. 2, and as described hereinabove, the system for selling products on-line 100 preferably includes a transaction server 102 and a web server 104 which is connected to the internet 106. Transaction server 102 and web server 104 are preferably interconnected via a computer network. Alternatively, transaction server 102 and web server 104 may reside on a single computer. System 100 also preferably includes a database 108.

Transaction server 102 preferably includes a seller module 200 which is operative to facilitate the offering of a product, by a seller, via interaction with a web site residing on web server 104, wherein the offering includes establishing a minimum price for the product, and establishing at least one of a target price, which is higher than the minimum price, and an offer expiration date. Details of the offering are preferably stored in database 108.

Transaction server 102 preferably also includes a buyer module 202 which is operative to facilitate the purchasing, by potential acquirers of the product, rights to participate in a draw for the product by interaction with the web site residing on web server 104. Record of purchase of rights to participate in draws is preferably stored in database 108.

Transaction server 102 preferably also includes a transaction engine 204, which is operative to automatically conduct the draw in accordance with predetermined criteria stored in database 108, which include both purchase, by potential acquirers of the product, of rights for a total amount which is not less than the minimum price, and either arrival of the offer expiration date or purchase by potential acquirers of the product of rights for a total amount which is not less than the target price.

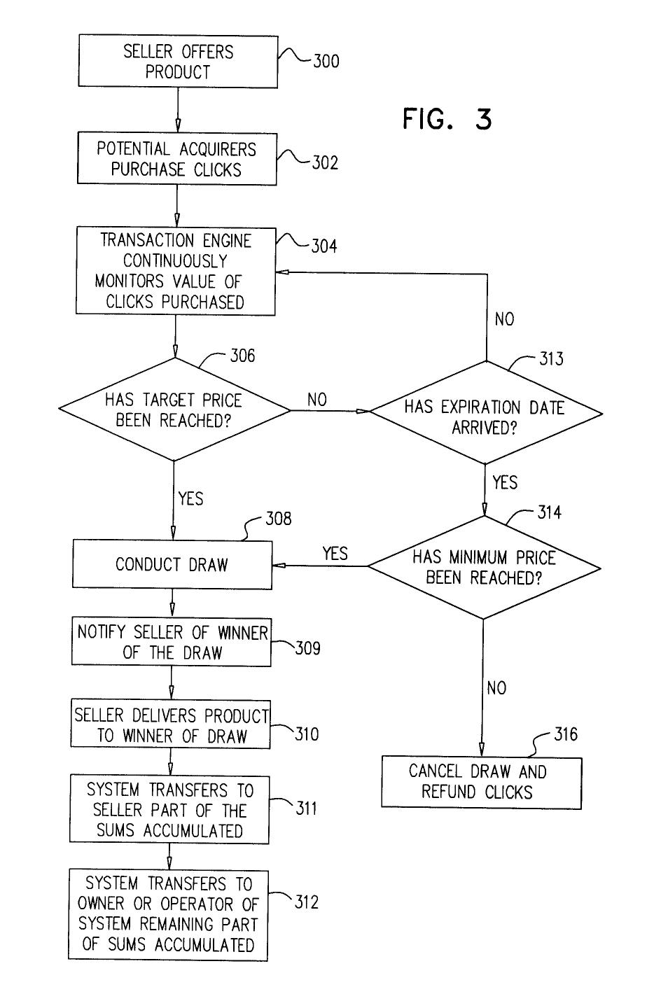

Reference is now made to FIG. 3, which is a simplified flow chart illustrating operation of the system of FIGS. 1A-2 in accordance with a preferred embodiment of the present invention.

As seen in FIG. 3, a seller offers a product for sale on-line (300) using the seller module 200 of FIG. 2. Once the product is offered for sale, potential acquirers of the product purchase rights to participate in a draw for the product (302) using the buyer module 202 of FIG. 2. The transaction engine 204 of FIG. 2 continuously monitors database 108 and compares the total value of clicks purchased for each product to the target price of the product as set by the seller of the product (304). If the total value of clicks purchased surpasses the target price (306), transaction engine 204 conducts the draw (308), notifies the seller of the winner of the draw (309), and after confirming that the seller has delivered the product to the winner of the draw (310), transfers to the seller part of the sums accumulated (311), and transfers to the owner or operator of the system the remaining part of the sums accumulated (312).

If the total value of clicks purchased has not surpassed the target price, transaction engine 204 checks whether the expiration date has arrived (313). If the expiration date has not yet arrived, the transaction engine 204 continues to monitor database 108 for additional data. If the expiration date has arrived, the transaction engine 204 compares the total value of clicks purchased for each product to the minimum price of the product as set by the seller of the product (314). If the total value of clicks purchased has surpassed the minimum price, transaction engine 204 conducts the draw (308), notifies the seller of the winner of the draw (309), and after confirming that the seller has delivered the product to the winner of the draw (310), transfers to the seller part of the sums accumulated (311), and transfers to the owner or operator of the system the remaining part of the sums accumulated (312). If the total value of clicks purchased has not surpassed the minimum price, transaction engine 204 cancels the draw and refunds the value of clicks purchased by all potential acquirers (316).

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. A system for selling products on-line comprising:
a seller module, providing the following functionality:
offering of a product, by a seller, by interaction with a web site;
establishing a minimum price for said product, by said seller, by interaction with said web site; and
establishing at least one of a target price, which is higher than said minimum price, and an offer expiration date, by said seller, by interaction with said web site;
a transaction engine publishing said offering of said product on said web site; and
a buyer module, providing the following functionality:
purchasing, by potential acquirers of said product, rights to participate in a draw for said product by interaction with said web site;
and wherein said transaction engine is operative to automatically conduct said draw in accordance with predetermined criteria which include both:
purchase by potential acquirers of said product of rights for a total amount which is not less than said minimum price; and
either arrival of said offer expiration date or purchase by potential acquirers of said product of rights for a total amount which is not less than said target price;
and wherein said transaction engine is also operative to award said product to the winner of said draw.

2. A system for selling products on-line according to claim 1 and wherein said predetermined criteria include both:
purchase by potential acquirers of the product of rights for a total amount which is not less than said minimum price; and
arrival of the offer expiration date.

3. A system for selling products on-line according to claim 1 and wherein said predetermined criteria include purchase by potential acquirers of the product of rights for a total amount which is not less than said target price.

4. A system for selling products on-line according to claim 1 and wherein said offering of a product includes providing descriptive details of said product.

5. A system for selling products on-line according to claim 1 and wherein said rights to participate in a draw include multiple rights to participate in said draw.

6. A system for selling products on-line according to claim 1 and wherein the price of said rights to participate in a draw is independent of the actual value of said product.

7. A system for selling products on-line according to claim 1 and wherein said transaction engine is also operative to notify said seller of the winner of said draw.

8. A system for selling products on-line according to claim 1 and wherein upon receiving confirmation of delivery of said product to said winner of said draw, said transaction engine is also operative to award said seller of said product the value of the total amount of rights purchased to participate in said draw.

9. A system for selling products on-line according to claim 1 and wherein said transaction engine is also operative to award said seller of said product part of the value of the total amount of rights purchased to participate in said draw and to transfer to an owner or an operator of said system a remaining part of the value of the total amount of rights purchased to participate in the draw for said product.

10. A system for selling products on-line according to claim 1 and wherein when said predetermined criteria are not fulfilled and said transaction engine does not automatically conduct said draw, said transaction engine is operative to refunds the total amount of rights purchased to participate in the draw for said product.

11. A method of selling products on-line comprising:
offering of a product, by a seller, by interaction with a web site;
establishing a minimum price for said product, by said seller, by interaction with said web site;
establishing at least one of a target price, which is higher than said minimum price, and an offer expiration date, by said seller, by interaction with said web site;
publishing said offering of said product on said web site;
purchasing, by potential acquirers of said product, rights to participate in a draw for said product by interaction with said web site;
automatically conducting said draw in accordance with predetermined criteria which include both:
purchase by potential acquirers of said product of rights for a total amount which is not less than said minimum price; and
either arrival of said offer expiration date or purchase by potential acquirers of said product of rights for a total amount which is not less than said target price; and
awarding said product to the winner of said draw.

12. A method of selling products on-line according to claim 11 and wherein said predetermined criteria include both:
purchase by potential acquirers of the product of rights for a total amount which is not less than said minimum price; and
arrival of the offer expiration date.

13. A method of selling products on-line according to claim 11 and wherein said predetermined criteria include purchase by potential acquirers of the product of rights for a total amount which is not less than said target price.

14. A method for selling products on-line according to claim 1 and wherein said offering of a product includes providing descriptive details of said product.

15. A method for selling products on-line according to claim 1 and wherein said rights to participate in a draw include multiple rights to participate in said draw.

16. A method for selling products on-line according to claim 1 and wherein the price of said rights to participate in a draw is independent of the actual value of said product.

17. A method for selling products on-line according to claim 1 and wherein said transaction engine is also operative to notify said seller of the winner of said draw.

18. A method for selling products on-line according to claim 1 and wherein upon receiving confirmation of delivery of said product to said winner of said draw, said transaction engine is also operative to award said seller of said product the value of the total amount of rights purchased to participate in said draw.

19. A method for selling products on-line according to claim 1 and wherein said transaction engine is also operative to award said seller of said product part of the value of the total amount of rights purchased to participate in said draw and to transfer to an owner or an operator of said web site a remaining part of the value of the total amount of rights purchased to participate in the draw for said product.

20. A method for selling products on-line according to claim 1 and wherein when said predetermined criteria are not fulfilled and said transaction engine does not automatically conduct said draw, said transaction engine is operative to refund the total amount of rights purchased to participate in the draw for said product.
